(19) United States
(12) Patent Application Publication
(10) Pub. No.: US 2007/0199722 A1
(43) Pub. Date: Aug. 30, 2007

(54) Christmas tree fire extinguisher

(76) Inventor: Ronald Bridge, Glendale, AZ (US)

Correspondence Address: MICHAEL WINFIELD GOLTRY, 4000 N. CENTRAL AVENUE, SUITE 1220, PHOENIX, AZ, 85012, US

(21) Appl. No.: 11/788,443

(22) Filed: Apr. 20, 2007

Related U.S. Application Data
(63) Continuation-in-part of application No. 10/778,877, filed on Feb. 13, 2004, now abandoned.
(60) Provisional application No. 60/447,462, filed on Feb. 14, 2003.

(51) Int. Cl. A62C 3/00

(52) U.S. Cl. 169/60; 169/70

(57) ABSTRACT

A Christmas tree fire extinguisher includes a source of fire retardant, a fire retardant dispersal element coupled to the source, a valve movable between a closed position and an open position permitting fire retardant to move forcibly from the source to the fire retardant dispersal element, a combustion sensor coupled to the valve in signal communication, and the valve movable from its closed position to its open position in response a sensing of combustion by the sensor.

### CROSS-REFERENCE TO THE RELATED APPLICATION

This application is a continuation-in-part of copending U.S. patent application Ser. No. 10/778,877, filed Feb. 13, 2004, which, in turn, claims the benefit of U.S. Provisional Patent Application Number 60/447,462, filed Feb. 14, 2003.

### FIELD OF THE INVENTION

The present invention relates to fire extinguishers.

### BACKGROUND OF THE INVENTION

Special fire safety precautions need to be taken when keeping a live Christmas tree in the house. A burning tree can rapidly fill a room with fire and deadly gas.

When choosing a tree, care should be taken to ensure that the tree is fresh, and that the needles are green and hard to pull back from the branches. The needles should not break if the tree has been freshly cut, and the trunk should be sticky to the touch. Old trees can be identified by bouncing the tree truck on the ground. If many needles fall off, the tree has been cut too long, has probably dried out, and is a fire hazard and should be avoided.

After choosing a fresh tree, careful consideration must be given to where it is placed in the home. For instance, a tree should not be positioned close to a heat source, such as a fireplace or a heat vent. The heat will dry out the tree, causing it to be more easily ignited by heat, flame, or sparks. Smokers should not drop or flick cigarette ashes near a tree, and a live tree should not be put up too early or left up for longer than two weeks. The tree should be mounted to a tree stand, which needs to be filled with water at all times.

If a tree is to be trimmed with holiday lights, the lights should be inspected for frayed wires, bare spots, gaps in insulation, broken or cracked sockets, and excessive kinking or wear before putting them on the tree. Only lighting listed by an approved testing laboratory should be used, and care must be taken not to link more than three light strands, unless the directions with the lights indicate it is safe to do so. It is also important to connect strings of lights to an extension cord before plugging the cord into an outlet, and all wires should be periodically inspected to make sure they are not warn to the touch.

Regardless of how much care one takes in choosing, installing, and trimming a tree, a live Christmas tree located within the home constitutes a fire risk. Although many homeowners are careful to have fire extinguishers on hand in the event the tree catches fire, a burning tree normally consumes a room with fire and deadly gas so quickly that homeowners are left with no other choice than to find their loved ones and evacuate the premises only to see their homes consumed by fire. Although the art is replete with various forms of fire extinguishers, relatively little effort has been devoted toward fire extinguishers that are specifically adapted to be used in conjunction with a Christmas tree.

### SUMMARY OF THE INVENTION

The above problems and others are at least partially solved and the above objects and others realized in a Christmas tree fire extinguisher, which consists of a source of fire retardant, a fire retardant dispersal element coupled to the source, a valve movable between a closed position and an open position permitting fire retardant to move forcibly from the source to the fire retardant dispersal element, a combustion sensor coupled to the valve in signal communication, and the valve movable from its closed position to its open position in response a sensing of combustion by the sensor. The fire retardant dispersal element consists of an elongate foraminous tube having a first end coupled to the source and an opposing second end. A decorative housing is coupled to the second end of the foraminous tube, and the sensor is carried by the decorative housing. In a particular embodiment, a conduit assembly couples the source to the first end of the elongate foraminous tube. In one embodiment, the combustion sensor is a heat detection sensor. In another embodiment, the combustion sensor is a smoke detection sensor.

Consistent with the foregoing summary of the invention and the ensuing specification, the invention also contemplates associated apparatus embodiments.

### BRIEF DESCRIPTION OF THE DRAWINGS

Referring to the drawings:

FIG. 1 is an isometric view of a Christmas tree fire extinguisher constructed in accordance with the teachings of the invention;

FIG. 2 is an exploded isometric view of the fire extinguisher of FIG. 1;

FIG. 3 is a front elevation of the fire extinguisher of FIG. 1;

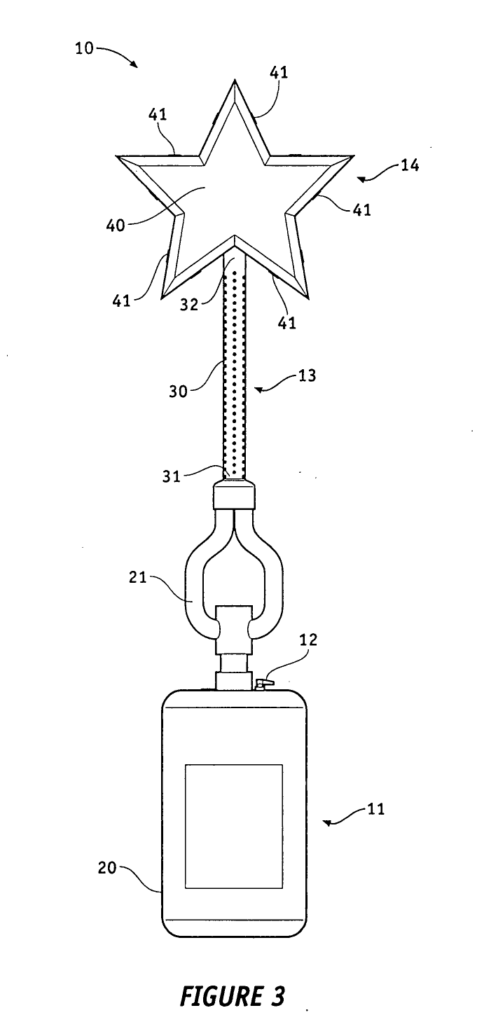

FIG. 4 is a side elevation of the fire extinguisher of FIG. 1;

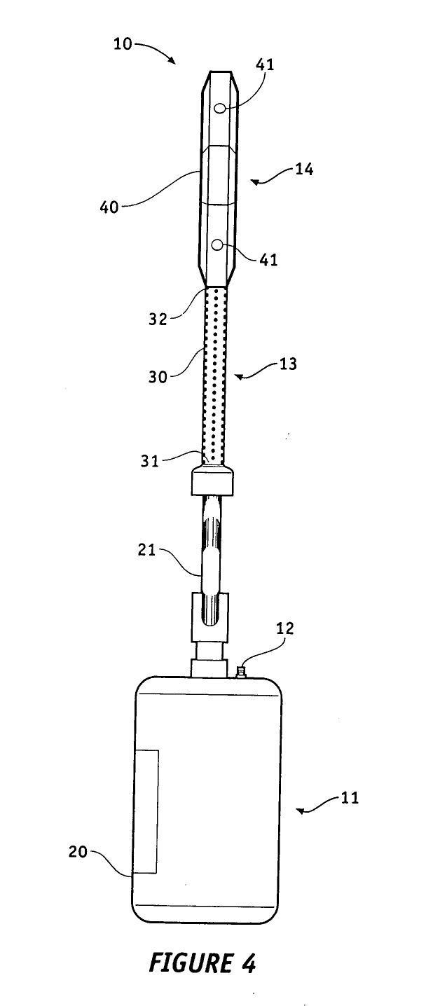

FIG. 5 is a top plan of the fire extinguisher of FIG. 1;

FIG. 6 is an isometric view of an alternate embodiment of a Christmas tree fire extinguisher constructed in accordance with the teachings of the invention; and

FIG. 7 is a vertical sectional view of a Christmas tree shown as it would appear having the Christmas tree fire extinguisher installed therewith.

### DETAILED DESCRIPTION OF PREFERRED EMBODIMENTS

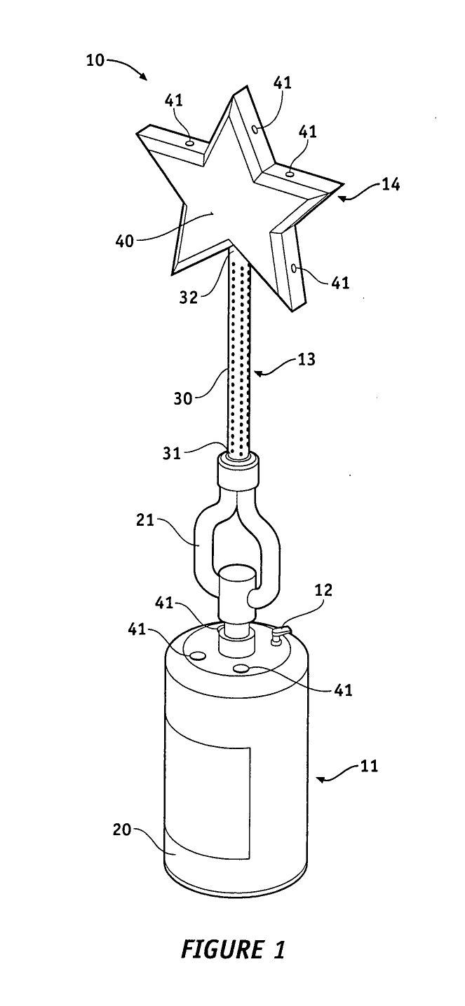

Turning now to the drawings, in which like reference characters indicate corresponding elements throughout the several views, attention is first directed to FIG. 1 in which is seen a Christmas tree fire extinguisher, embodying the principle of the instant invention, generally indicated by the reference character 10 including a source 11 of fire retardant, a valve 12, a retardant dispersal element 13 and a detection assembly 14. Source 11 is constructed and arranged much like a conventional fire extinguisher, and includes a cannister 20 that contains fire retardant material maintained under pressure. The fire retardant material is any suitable dry or wet fire retardant material, and cannister is rechargeable, if desired.

A conduit assembly 21 couples cannister 20 to dispersal element 13. In the immediate embodiment, a pair of cooperating conduits characterizes conduit assembly 21, although less or more can be used. Dispersal element 13 consists of an elongate, foraminous tube 30 having a proximal end 31 coupled to conduit assembly 21 and a distal end 32 attached to detection assembly 14. Any suitable means of attachment can be used to couple proximal end 31 to conduit assembly 21 and distal end 32 to detection assembly, such as welding, threaded attachment, adhesive attachment, etc. Tube 30 is fashioned from any suitable flexible or non-flexible fire-resistant material or combination of materials, and is formed with formina or openings, which extend therethrough and are dispersed in one or more regular and/or irregular patterns extending substantially from proximal end 31 to distal end 32. If desired, dispersal element 31 can be coupled directly to source 11 without the provision of conduit assembly 21.

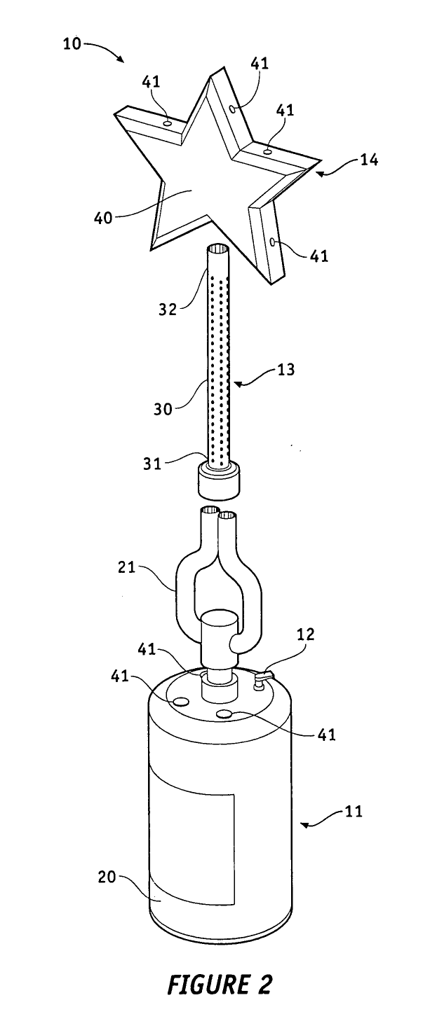

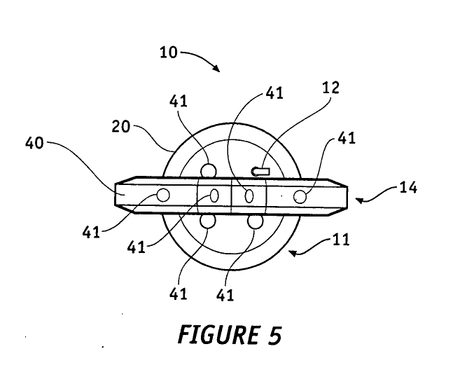

Detection assembly 14 consists of a housing 40, which is constructed of any suitable flexible or non-flexible fire-resistant material or combination of materials and supports sensors 41 and contains a power source, such as one or more conventional non-rechargeable and/or rechargeable batteries. Conventional electrical interconnections and circuitry (not shown) are used connect the power source to sensors 41 and to valve 12 and to facilitate signal communication between sensors 41 and valve 12. Sensors 41 are combustion sensors, namely, conventional heat and/or smoke detection sensors, that each in response to sensing heat and/or smoke, which are each a byproduct of combustion, generates and sends a signal to valve 12 causing it to move from its normal closed position to an open position. When valve 12 moves into its open position, fire retardant material passes forcibly from cannister 20 to dispersal element 13 through conduit assembly 21 and is dispersed forcibly from dispersal element 13 through its foramina so as to be applied to fire. Sensors 41 are disposed at a spaced intervals and any desired number can be used, whether two or more. Only one sensor 41 can be used, if desired. Sensors 41 can be attached at other locations, such as to cannister 20 as illustrated in FIGS. 1, 2, and 5.

In accordance with the principle of the invention, housing 40 is decorative in nature, and resembles a star in the immediate embodiment. Housing 40 can be made in other decorative forms, such as an angle, a decorative ball, or any other desired ornamentation form.

In use, extinguisher 10 is installed with a Christmas tree. In a typical installation, extinguisher 10 is secured to the branches and or trunk of a Christmas tree, such as with tying or the like, so as to dispose housing 40 at the top of the Christmas tree so as to act as the decorative top of the Christmas tree. Should Christmas tree catch fire, such as from defective wiring from Christmas lights, the fire will generate heat and smoke. In response to sensing heat and/or smoke from the fire, sensors 41 are responsive and generate signals to valve 12 causing it to move from its normal closed position to an open position. When valve 12 moves into its open position as previously explained, the fire retardant material maintained by cannister 20 passes forcibly from cannister 20 to dispersal element 13 through conduit assembly 21 and is dispersed forcibly from dispersal element 13 through its foramina so as to be applied to the fire to extinguish/suppress it. A plurality of sensors 41 are used for redundancy in case certain ones of sensors 41 fail for some reason. Nevertheless, and as previously explained, only one sensor 41 can be used with the invention.

Although the power source of the invention consists of one or more conventional batteries, whether rechargeable, maintained and supported by housing 40, the power source can be supported elsewhere, such as at cannister 20. Extinguisher 10 can, if desired, be provided with a conventional power cord of the type for engaging a wall outlet for providing sensors 41 and valve 12 with electrical power. Also, in an effort to inhibit extinguisher 10 from catching fire, it is preferred that the various elements of extinguisher 10 be fashioned of fire resistant materials. It is to be understood that although the invention is particularly useful in a Christmas tree application, it is useful in other applications. In this vein, housing 40 can be of any desired design, whether secular or non-secular.

In a particular embodiment, sensors 41 are heat sensors and the invention is configured with a temperature sensor set at a predetermined threshold temperature, in which the sensors 41 will only activate to open valve 12 when the sensed temperature reaches the threshold temperature. In another embodiment, sensors 41 are configured to activate and send signals to valve 12 to open it only in response to sensing both smoke and heat. In still another embodiment, the invention is configured with an alarm, which is activated by sensors 41 in response to sensing heat, smoke, or heat and smoke, for the purposes of alerting occupants of the household to the threat of fire. The alarm can be an audible alarm for issuing an audible stimulus, a visual alarm for issuing a visual stimulus, or a combination thereof. In yet another embodiment, the invention is configured with a “kill” or “override” switch, which when activated deactivates extinguisher 10.

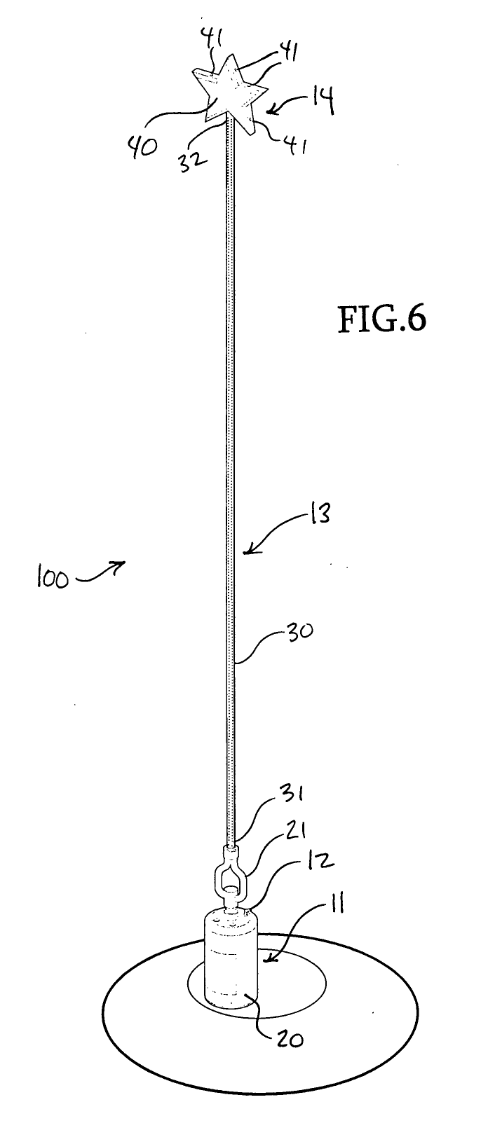

Referring now to FIG. 6 there is seen an isometric view of an alternate embodiment of a Christmas tree fire extinguisher constructed in accordance with the teachings of the invention and generally designated by the reference character 100. In common with the previously-described extinguisher designated at 10, extinguisher 100 shares source 11 of fire retardant including canister 20, valve 12, retardant dispersal element 13, detection assembly 14 including housing 40 and sensors 41, and conduit assembly 21 coupling cannister 20 to dispersal element 13. In the present embodiment, dispersal element 13 consists of elongate, foraminous tube 30 having a pattern of foramina formed therethrough and a proximal end 31 coupled to conduit assembly 21 and distal end 32 attached to detection assembly 14. Unlike the embodiment designated at 10, elongate, foraminous tube 30 is considerably longer than the elongate, foraminous tube discussed in conjunction with extinguisher 10.

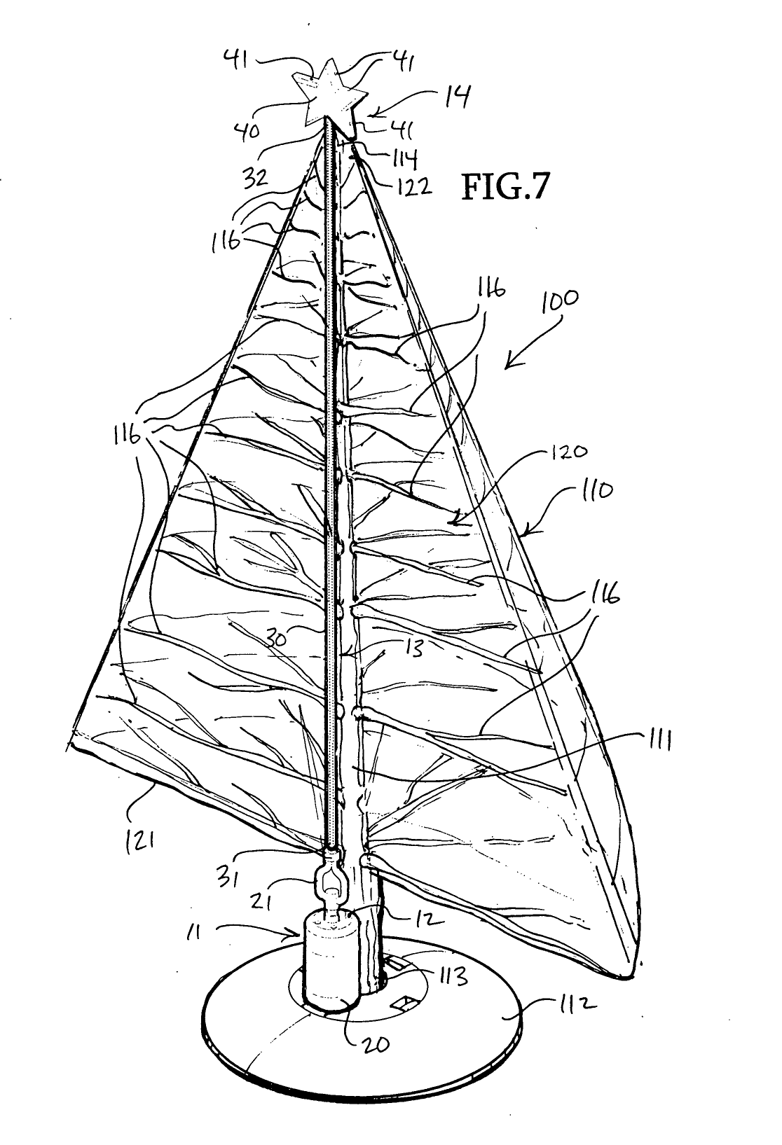

Looking now to FIG. 7 there is seen a vertical sectional view of a Christmas tree 110 including a trunk 111 extending upright from a base 112. Trunk 111 has a lower extremity 113 secured at tree stand or base 112, and an opposed upper extremity 114. Secondary branches 116 are supported on trunk 111, and extend along substantially the entire length of trunk 111 from adjacent to lower extremity 113 to upper extremity 114, whereby a portion of the length of trunk 111 extending upwardly from lower extremity 114 is generally free of branches as illustrated. Branches 116 form a branched structure of tree, which is designated generally at 120. Branched structure 120 has a lower end 121 adjacent to lower extremity 113 of trunk 111, and an upper end 122 at upper extremity 114 of trunk 111. Branch structure 120 is generally cone-shaped having a broad base constituting lower end 121, and which gradually tapers upwardly therefrom to a relative pointed top at upper end 122.

In use, extinguisher 100 is installed with Christmas tree 110. According to the present embodiment, extinguisher 100 is secured to branches 116 and/or trunk 111 of tree 110, such as with tying or the like, disposing housing 40 of detection assembly 14 at the top of the tree 110 formed by upper extremity 114 of trunk 111 and upper end 112 of branched structure 120 so as to act as the decorative top of tree 110. Housing 40 extends upwardly relative to upper extremity 114 of trunk 111 and upper end 122 of branched structure 120 as illustrated. In the present embodiment, elongate, foraminous tube 30 extends downwardly from housing 40, from distal end 32, in juxtaposition with or otherwise along trunk 111 to proximal end 31 coupled to conduit assembly 21 coupling cannister 20 to elongate, foraminous tube 30. Cannister 20 rests atop base 112 to which lower extremity 113 of trunk 111 is secured, and elongate, foraminous tube 30 extends along trunk 111 along generally the entire length of branched structure 120 from lower end 121 of branched structure 120 to upper end 112 of branched structure 120, in which proximal end 31 of elongate, foraminous tube 30 is located proximate to lower end 121 of branched structure 120, and distal extremity 32 of elongate, foraminous tube 30 is located proximate to upper end 122 of branched structure 120. If desired, elongate, foraminous tube 30 can be wrapped around trunk 111 and constructed of such a length ensuring that elongate, foraminous tube 30 extends along trunk 111 along generally the entire length of branched structure 120 from lower end 121 of branched structure 120 to upper end 112 of branched structure 120 as herein disclosed, such that proximal end 31 of elongate, foraminous tube 30 is located proximate to lower end 121 of branched structure 120, and distal extremity 32 of elongate, foraminous tube 30 is located proximate to upper end 122 of branched structure 120.

With continuing reference to FIG. 7, should tree 110 catch fire, such as from defective wiring from Christmas lights, the fire will generate heat and smoke. In response to sensing heat and/or smoke from the fire, sensors 41 are responsive and generate signals to valve 12 causing it to move from its normal closed position to an open position. When valve 12 moves into its open position, the fire retardant material maintained by cannister 20 passes forcibly from cannister 20 to elongate, foraminous tube 30 through conduit assembly 21 and is dispersed forcibly from the foramina formed in elongate, foraminous tube 30 along the entire length of elongate, foraminous tube 30 from proximal end 31 at lower end 121 of branched structure 120 to distal end 32 at upper end 122 of branched structure 120 thereby applying the fire retardant outwardly from elongate, foraminous tube 130 onto trunk 111 and into and through branched structure 120 from lower end 121 of branched structure 120 to upper end 122 of branched structure 120 thereby providing fire suppression along the trunk 111 and in and throughout branched structure 120.

The invention has been described above with reference to preferred embodiments. However, those skilled in the art will recognize that changes and modifications may be made to the described embodiments without departing from the nature and scope of the invention. Various changes and modifications to the embodiments herein chosen for purpose of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. In a tree including a trunk having a lower extremity secured at a base and an opposed upper extremity and a first length extending from the lower extremity of the trunk to the upper extremity of the trunk, secondary branches supported on the trunk extending along substantially the entire first length of the trunk from adjacent to the lower extremity of the trunk to the upper extremity of the trunk, the branches forming a branched structure of the tree and having a lower end adjacent to the lower extremity of the trunk, an upper end at the upper extremity of the trunk, and a second length extending from the lower end of the branched structure to the upper end of the branched structure, improvements therein comprising:
a source of fire retardant;
an elongate tube having a proximal end coupled to the source of fire retardant, an opposed distal end, a third length extending from the proximal end of the elongate tube to the distal end of the elongate tube, and a pattern of formina formed through the elongate tube from the proximal end of the elongate tube to the distal end of the elongate tube;
the elongate tube juxtaposed along the trunk extending along generally the entire second length of the branched structure from the lower end of the branched structure to the upper end of the branched structure, the proximal end of the elongate tube located proximate to the lower end of the branched structure, and the distal extremity of the elongate tube located proximate to the upper end of the branched structure; and
a valve movable between a closed position and an open position permitting fire retardant to move forcibly from the source into the elongate tube through the proximal end thereof and outwardly from the foramina formed through the elongate tube along the entire length of the elongate tube from the proximal end thereof to the distal end thereof thereby applying the fire retardant outwardly from the elongate tube onto the trunk and into and through the branched structure from the lower end of the branched structure to the upper end of the branched structure thereby providing fire suppression along the trunk and the branched structure.

2. The improvements according to claim 1, further comprising:
a combustion sensor coupled to the valve in signal communication; and
the valve movable from the closed position to the open position in response a sensing of combustion by the sensor.

3. The improvements according to claim 2, further comprising:
a decorative housing coupled to the distal end of the elongate tube; and
the sensor carried by the decorative housing.

5. The improvements according to claim 2, wherein the combustion sensor is a heat detection sensor.

6. The improvements according to claim 2, wherein the combustion sensor is a smoke detection sensor.

7. The improvements according to claim 1, further comprising a conduit assembly coupling the source to the proximal end of the elongate tube.

8. The improvements according to claim 1, wherein the source comprises a canister of the fire retardant material located atop the base.
